(19) United States
(12) Patent Application Publication
(10) Pub. No.: US 2008/0271760 A1
(43) Pub. Date: Nov. 6, 2008

(54) Method and Composition

(75) Inventors: Chris Efstathios Housmekerides, Ludwigshafen (DE); Dietmar Van Loyen, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., WT Hoofddorp (NL)

(21) Appl. No.: 12/096,422

(22) PCT Filed: Dec. 13, 2006
(86) PCT No.: PCT/GB2006/004659

§ 371 Date: Jun. 23, 2008

(30) Foreign Application Priority Data
Dec. 13, 2005 (GB) 0525314.1

(51) Int. Cl. B08B 9/20; C11D 3/02

(52) U.S. Cl. 134/25.2; 510/220

(57) ABSTRACT

A process for cleaning an automatic dishwashing machine comprises delivering into the machine a machine cleaning composition suitably containing an acid or builder, followed by delivering into the machine a dishwashing composition. Conveniently the process involves delivering the machine cleaning composition directly to the main washing chamber of the machine, charging the delivery compartment of the machine with the dishwashing composition; and carrying out a wash with kitchenware articles inside, using a cycle which includes a pre-wash stage.

This invention relates to a method of cleaning automatic dishwashing (ADW) machines, and to a product for cleaning ADW machines.

ADW machines are popular with consumers due to the time and effort that they save. They also typically provide high cleaning performance and thus high consumer satisfaction.

However, over time, the machines themselves may become soiled leading to a perceived or actual decrease in performance. This in turn leads to reduction in consumer satisfaction.

A “soil” commonly found in ADW machines is limescale: a residue of calcium carbonate may build up over time, particularly in hard water areas. Similar problems may also occur in areas where there is a high concentration of magnesium ions in the water. Insoluble salts of magnesium and calcium (scale) deposit on the internal surfaces of ADW machines.

Scum may also form.

Grease-containing residues may also be present.

The formation of scale and scum may be avoided by the addition of builders to dishwashing compositions. However, for environmental and economic reasons, it is undesirable to include high levels of such components in all dishwashing compositions, as many consumers live in soft water areas where the amounts of calcium and magnesium ions found in the water supply are low.

As it is not always possible to prevent the build up of undesired residues in hard water areas, it has been necessary to find methods of breaking down such residues. These residues are typically basic and thus can be broken down by the addition of an acidic component. However, as dishwashing compositions are typically basic compositions, an acidic component cannot easily be incorporated therein.

A solution offered by the prior art has been to provide an acidic composition which is used to clean a machine during a cycle of the machine which is run without kitchenware articles present, i.e. when the machine is empty. However this has been found to be wasteful and inconvenient. The consumer must find a time when the machine is empty and then use resources—the machine cleaning composition, water and electricity—to clean only the machine.

It is an object of the present invention to provide a process for cleaning ADW machines which overcomes at least one of the aforementioned disadvantages.

According to a first aspect of the present invention, there is provided a process for cleaning an automatic dishwashing machine during a working cycle thereof, the machine being loaded with kitchenware articles to be cleaned, the process comprising delivery into the machine of a machine cleaning composition, followed by delivery into the machine of a dishwashing composition.

Preferably the dishwasher composition is delivered into the working cycle at least 3 minutes after the machine cleaning composition is delivered into the working cycle; preferable at least 5 minutes, most preferably at least 10 minutes.

The machine cleaning composition and the dishwashing composition could be comprised within the same product, but arranged to be released at different times. This could be achieved by providing them in two compartments with walls having different solubility characteristics; or with the machine cleaning composition provided around a core of the dishwashing composition; or with the machine cleaning composition being less heavily compressed that the dishwashing composition; or with only the machine cleaning composition part having a disintegrating aid.

The machine cleaning composition and the dishwashing composition could be comprised within two separate products, with different solubility characteristics. For example the machine cleaning composition may be less heavily compressed that the dishwashing composition; or only the machine cleaning composition may have a disintegrating aid; or the two products may have walls of different materials, with different solubility profiles, per se or as a function of temperature or pH. For example the wall material for the machine cleaning composition may dissolve in cold water at neutral pH but the wall material for the dishwashing composition preferably does not. Suitably the wall material for the dishwashing composition dissolves in water above 40° C., preferably above 50° C.

Most preferably, however, the process is carried out using two different additions, of machine cleaning composition and of the dishwashing composition, making use of an ADW machine cycle having a pre-wash stage and a main wash stage.

The preferred process of the invention is thus carried out in a machine having a main washing chamber and a compartment for the dishwashing composition, the process comprising the steps of:
adding a machine cleaning composition directly to the main washing chamber of the machine;
charging the delivery compartment with the dishwashing composition; and
running a working cycle of the machine, wherein said working cycle selected includes a pre-wash stage;

wherein the machine cleaning composition is active in the pre-wash stage and the dishwashing composition is released from the delivery compartment only in the main wash stage.

Many of the definitions which follow are presented in the context of the preferred process, which exploits the pre-wash possibility. Nevertheless they apply to the other possibilities stated above for carrying out this invention, unless that possibility is not possible or precluded by express statement.

The steps of adding the machine cleaning composition and charging the delivery compartment with the dishwashing composition may be carried out in either order or simultaneously.

ADW machines usually provide a choice of at least two wash cycles so that the consumer may choose the appropriate cycle depending on the degree of soiling of the kitchenware articles to be washed. At least one of these cycles typically includes a pre-wash stage, in addition to a main wash. A main wash only may often be selected as an alternative. When the appropriate cycle is selected a pre-wash stage is performed prior to the main wash and may include a process of rinsing the kitchenware articles usually with cold water.

Some, newer, machines “decide” for themselves whether to use a pre-wash stage. A light cell is typically used to measure the turbidity of the wash water. If the water is dirty it will be turbid; this a sign that the kitchenware articles are heavily soiled and a cycle including a pre-wash is automatically selected.

Suitably the machine cleaning composition may include a component which automatically triggers the selection of a cycle which includes a pre-wash stage. The component is herein called a turbidity agent. It may, for example, be a soluble dye, a dispersible pigment or any other form of opacifier.

Therefore, in a preferred process of the present invention only the machine cleaning composition is present during the pre-wash stage of the working cycle and the dishwashing composition is added during the later main wash stage. Thus, components which are incompatible may be used in the separate machine cleaning and dishwashing compositions.

By working cycle in this specification it is to be understood that the process of the present invention is carried out when the ADW machine is loaded with kitchenware articles to be washed. Thus cleaning of the machine is achieved during the same cycle as the washing of kitchenware articles.

The term “kitchenware articles” is intended to include crockery, pans, pots, cutlery, glasses and any other suitable kitchenware articles which may be washed using an ADW machine.

The dishwashing composition (i.e. detergent composition) used in the process of the present invention may comprise any suitable composition, including any dishwashing composition available on the market; the invention does not reside it the selection of the dishwashing composition. Dishwashing compositions are well known to those skilled in the art and typically comprise surfactants, builders, enzymes and/or bleaches. They may be provided in the form or powder, tablets, gelcaps and liquids. In the process of the present invention, a standard dose of a standard dishwashing composition may be used by the consumer. For example any commercial tablet may be used.

The dishwashing composition may be standard and need not be described further. However the machine cleaning composition for use in the present invention will now be further described.

The machine cleaning composition for use in the process of the present invention may comprise an acid. It may comprise more than one acid.

Suitable acids include organic acids and/or inorganic acids.

Suitable inorganic acids for use in the process of the present invention include sulfamic acid and phosphoric acid.

Suitable organic acids for use in the present invention include carboxylic acids. These may be monocarboxylic acids or polycarboxylic acids, for example those having from 2 to 4 carboxylic groups.

Polycarboxylic acids which comprise one carboxyl group include, for example, formic acid, acetic acid, propanoic acid, trimethylacetic acid, caproic acid, stearic acid, acrylic acid, benzoic acid, salicylic acid, and anthranilic acid.

Polycarboxylic acids which comprise two carboxyl groups include, for example, oxalic acid, malonic acid, succinic acid, glutaric acid, adipic acid, tartronic acid, maleic acid, fumaric acid, diglycolic acid, (ethylenedioxy)diacetic acid, tartaric acid, malic acid and phthalic acid.

Polycarboxylic acids which contain three carboxyl groups include, for example, citric acid.

Polycarboxylic acids which contain four carboxyl groups include, for example, pyromellitic acid.

Preferably the inorganic acid is present in the composition in an amount of at least 10 wt %, preferably at least 20 wt %, more preferably at least 30 wt %, preferably at least 40 wt % and most preferably at least 50 wt %.

Preferably the inorganic acid is present in an amount of up to 90 wt %, preferably up to 80 wt %, more preferably up to 70 wt %, and most preferably up to 60 wt %.

Preferably the organic acid is present in the machine cleaning composition in an amount of at least 5 wt %, preferably at least 10 wt %, more preferably at least 15 wt % and most preferably at least 20 wt %.

Preferably the organic acid is present in an amount of up to 50 wt %, preferably up to 40 wt %, more preferably up to 35 wt % and most preferably up to 30 wt %.

Preferably the machine cleaning composition comprises, in total at least 50 wt %, acid, more preferably at least 60 wt %, most preferably at least 70 wt %.

Preferably the machine cleaning composition comprises up to 100 wt % acid, more preferably up to 90 wt % and most preferably up to 80 wt % acid.

In the preceding two paragraphs, the amounts present refer to the total amount of any and all acids in the machine cleaning composition for use in the process of the present invention.

There may be more than one organic acid. Preferably, however, there is only one organic acid present in the machine cleaning composition for use in the process of the present invention.

There may be more than one inorganic acid present. Preferably, however, there is only one inorganic acid present in the machine cleaning composition for use in the process of the present invention.

Preferred inorganic acids for use in the present invention include phosphoric acid, and especially sulfamic acid.

Preferred organic acids for use in the present invention include di- and tri-carboxylic acids for example citric acid, and especially, maleic acid.

Preferably, the machine cleaning composition for use in the process of the present invention comprises both an inorganic acid and an organic acid.

In a composition having both inorganic acid and organic acid, preferably the ratio of inorganic acid to organic acid is at least 0.5 to 1, preferably at least 1 to 1, more preferably at least 1.5 to 1, and most preferably at least 2 to 1 (wt:wt).

Preferably the ratio of inorganic acid to organic acid is less than 5 to 1, more preferably less than 4 to 1, preferably less than 3 to 1, and most preferably, less than 2.5 to 1 (wt:wt).

Preferably a machine cleaning composition used in the process of the present invention and comprising an acid is such that a 10 wt % aqueous solution of the composition has a pH of between 0.5 and 6.5, more preferably between 1 and 5 and most preferably between 2 and 4.

Preferably a machine cleaning composition used in the process of the present invention and comprising a builder is such that a 10 wt % aqueous solution of the composition has a pH of between 8 and 13, more preferably between 9 and 11 and most preferably between 9.5 and 10.5.

In alternative embodiments the machine cleaning composition for use in the process of the present invention may comprise a builder. It may comprise more than one builder.

Suitable builders for use in the machine cleaning composition may include phosphorous builders, of which mono-phosphates, di-phosphates, tri-polyphosphates or oligomeric-poylphosphates are preferred. The alkali metal salts of these compounds are preferred, in particular the sodium salts. An especially preferred builder is sodium tripolyphosphate (STPP).

Suitable builders for use in the machine cleaning composition may include non-phosphorous based builders.

Non-phosphorous based builders may be organic molecules with carboxylic group(s), amino acid based compounds or succinate based compounds. The terms ‘succinate based compounds’ and ‘succinic acid based compounds’ are used interchangeably herein.

Builders which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred builder is sodium citrate.

Preferred examples of amino acid based compounds which can be used as builders in machine cleaning compositions according to the invention are MGDA (methyl-glycine-diacetic acid, and salts and derivatives thereof) and GLDA (glutamic-N,N-diacetic acid and salts and derivatives thereof). GLDA (salts and derivatives thereof) is especially preferred according to the invention, with the tetrasodium salt thereof being especially preferred.

Other suitable builders are described in U.S. Pat. No. 6,426,229 which is incorporated by reference herein.

Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA), ethylenediaminetetraacetic acid (EDTA), nitrilotriacetic acid (NTA), diethylenetriaminepentaacetic acid (DTPA), N-hydroxyethyl ethylenediamine triacetic acid (HEDTA), ethyleneglycol bis(2-aminoethylether)-tetraacetic acid (EGTA), ethylenediamine-N,N′-disuccinic acid (EDDS) and sulfomethyl-N,N-diacetic acid (SMDA) and alkali metal salts or ammonium salts thereof.

Preferred succinate compounds which can-be used in machine cleaning compositions in accordance with the present invention are described in U.S. Pat. No. 5,977,053 and have the formula

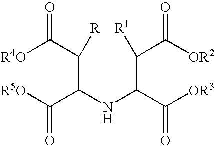

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms. A preferred example is tetrasodium iminosuccinate.

The machine cleaning compositions of the invention may further comprise a secondary builder (or co-builder). Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts.

Secondary builders which are organic are preferred.

Suitable polycarboxylic acids are acyclic, alicyclic, heterocyclic and aromatic carboxylic acids, in which case they contain at least two carboxyl groups which are in each case separated from one another by, preferably, no more than two carbon atoms.

Polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid.

Another polycarboxylic acid suitable as a secondary builder for use in a machine cleaning process of the present invention is the homopolymer of acrylic acid. Other suitable builders are disclosed in WO 95/01416, to the contents of which express reference is hereby made.

Preferably the total amount of builder present (including any secondary builder or co-builder) in the machine cleaning compositions of the invention is an amount of at least 20 wt %, preferably at least 40 wt %, more preferably at least 60 wt %, and most preferably at least 75 wt %, preferably in an amount of up to 100 wt %, preferably up to 90 wt %. The actual amount used will depend upon the nature of the builder used.

Preferably the total amount of builder present (including any secondary builder or co-builder) in the machine cleaning compositions of the invention is an amount of at least 2 g, preferably at least 4 g, more preferably at least 6 g, and most preferably at least 10 g, and preferably in an amount of up to 30 g, preferably up to 20 g, preferably up to 15 g. The actual amount used will depend upon the nature of the builder used.

In the process of the present invention, the machine cleaning composition is added within the main washing chamber of the machine. This chamber is the area where the kitchenware articles to be washed are stacked and is separate to the delivery compartment in which the dishwashing composition is placed.

The machine cleaning composition may be placed anywhere within this compartment and may be provided in any suitable form. For example, it may be provided in the form of a powder which can be sprinkled throughout the machine. It could be provided in the form of a liquid which could be poured or sprayed. It could be dispensed as a foam or gel.

Preferably the machine cleaning composition for use in the process of the present invention is provided in the form of a unit dose. This unit dose may take any suitable form, for example a liquid or gel capsule or sachet comprising a powder. Such items may comprise an outer coating made from a water soluble polymer, for example a polyvinyl alcohol. Polyvinyl alcohols suitable for such use are well known to those skilled in the art.

Preferably the machine cleaning composition for use in the present invention is provided in the form of a tablet of compressed powder, as a unit dose. Such tablets are formed by conventional methods and also are well understood by those skilled in the art.

Preferably the tablets of the machine cleaning composition used in the process of the present invention have a mass of between 1 and 100 g, more preferably between 5 and 50 g, and most preferably of between 10 and 20 g.

In addition to the acid(s) discussed above, such a machine cleaning composition may further comprise optional extra excipients. These include, for example, surfactants, solvents, preservatives, fragrances, antifoams, thickeners, colorants, lubricants, processing aids, and fillers. Builders are not preferred, but are not excluded.

In addition to the builder(s) discussed above, such a machine cleaning composition may further comprise optional extra excipients. These include, for example, surfactants, solvents, preservatives, fragrances, antifoams, thickeners, colorants, lubricants, processing aids, and fillers. Acids are not preferred, but are not excluded.

Preferred surfactants, when present, are non-ionic surfactants, in particular alkoxylated compounds or mixtures thereof.

Preferably the alkoxylated compound, when present, is an alkoxylated alcohol, especially alcohol ethoxylate, but alcohol propoxylates and mixed alcohol ethoxylates/propoxylates are not excluded. A preferred alkoxylated alcohol for use in this invention is an alcohol ethoxylate having an average 6-20 carbon atoms in the “body”, preferably 7-15 especially 7-13, most preferably 9-11; and an average 2-14 moles per mole alcohol, of ethylene oxide in the “tail”, preferably 2-8, more preferably 3-5 moles.

In some embodiments the machine cleaning composition used in the process of the present invention further comprises a disintegration aid, for example a water-swellable compound, for example a water-swellable cellulose compound. Alternatively the disintegration aid may be a base, with which an acid present reacts. As a result of such reaction the composition may be rapidly dissolved; and the agitation may assist cleaning.

A disintegration aid present is preferably present in an amount of up to 30 wt %, more preferably up to 25 wt %.

When present, a disintegration aid is preferably present in an amount of at least 5 wt %, more preferably at least 10 wt %, most preferably at least 15 wt %.

Suitable disintegration aids include the alkali metal salts of hydroxides, carbonates and bicarbonates. A preferred disintegration aid and/or base, when present, is sodium bicarbonate.

In the process of the present invention, the machine cleaning composition is preferably placed on the floor of the main washing chamber, or put into the cutlery basket, or simply thrown into the chamber. Some ADW machines have a pre-wash compartment, into which it may be placed. The machine cleaning composition is preferably dispersed completely within 5 minutes of the start of the working cycle, more preferably within 3 minutes, most preferably within 2 minutes.

In embodiments of the invention which use acid(s) the wash liquor within the ADW machine preferably has a pH immediately following dissolution of the machine cleaning composition of between 1 and 4, more preferably of between 2 and 3, especially between 2 and 2.5.

In embodiments of the invention which use builders(s) the wash liquor within the ADW machine preferably has a pH immediately following dissolution of the machine cleaning composition between 8 and 13, more preferably between 9 and 11, more preferably between 9.5 and 10.5.

The pre-wash stage of the working cycle may take from 5 to 25 minutes, usually from 5 to 10 minutes.

Preferably by the end of the pre-wash stage of the working cycle, the wash liquor preferably has a pH of between 5 and 7, more preferably between 6 and 7, using acidic machine cleaning compositions, and between 9 and 13, using builders.

The increase in pH in acidic compositions occurs as the acid reacts with scale and other basic deposits and is neutralised. Preferably the liquid from the pre-wash is expelled from the machine before the main wash commences and the dishwashing composition is added.

Preferably the pre-wash stage is carried out in water at ambient temperature; preferably having a temperature in the range 10-25° C.

A preferred process for cleaning an automatic dishwashing machine during its working cycle comprises the steps of:
adding within the main washing chamber of the machine a machine cleaning composition comprising either 50-60 wt % sulfamic acid, 20-30 wt % maleic acid and 15-25 wt % sodium bicarbonate, or 60-100 wt % of an amino acid based builder;
charging the delivery compartment with a dose of dishwashing composition; and
running a working cycle of said dishwashing machine which includes a pre-wash stage;
   wherein during the cycle the machine cleaning composition is active in the pre-wash stage and the dishwashing composition is released only in the main wash stage.

According to a second aspect of the present invention there is provided the use of an acid in a machine cleaning composition to effect cleaning of an automatic dishwashing machine during a pre-wash stage of a working cycle of the machine.

According to a third aspect there is provided the use of a builder in a machine cleaning composition to effect cleaning of (and preferably combat scale in) an automatic dishwashing machine during a working cycle of the machine. A builder may be present in a dishwashing (i.e. detergent) composition to combat scale, but preferably a builder is provided in a composition present in a pre-wash stage of the working cycle, to function in this way.

According to a fourth aspect there is provided the use of MGDA in combating scale in an automatic dishwashing machine. The MGDA may be present in a dishwashing (i.e. detergent) composition to combat scale, but is preferably provided in a composition present in a pre-wash stage, in order to combat scale.

By combat scale we mean inhibit the deposition of scale on a surface and/or removal of existing scale from a surface.

According to a fifth aspect there is provided a machine cleaning composition comprising a compound which counteracts calcium or magnesium ions, and/or scale or scum formed thereby, together with a turbidity agent.

In the use of the second, third, fourth or fifth aspect, the machine cleaning composition used may comprise any of the features, including components and amounts, of the machine cleaning composition described in relation to the process of the first aspect of the invention.

The invention will now be further described by way of the following non-limiting examples.

### EXAMPLE 1

A machine cleaning composition of the acidic type was prepared comprising the following components:

56 wt % sulfamic acid

24 wt % maleic acid

20 wt % sodium bicarbonate

The composition was prepared in the form of tablets having a mass of 16 g, by standard compression-forming.

In order to test the effectiveness of the process, the following experiment was carried out.

An ADW machine, (a Bosch Silence Comfort machine) was soiled with a mixture of MgSO₄:7H₂O, CaCl₂:2H₂O and NaHCO₃. The machine was heavily and visibly soiled.

The machine was then loaded with a standard dose of a dishwashing composition (one Calgonit (™) 3-in-1 tablet) and run on a main wash (a 50° C. cycle) using water of hardness 18° dH. The machine was hardly improved; the dishwashing composition was substantially ineffective at removing scale.

The machine was then loaded with the same dishwashing composition, placed in compartment, and a tablet of machine cleaning composition as described above was placed on the floor of the main chamber. The machine was then run on a normal working cycle which included pre-wash and main-wash stages. The machine was rendered sparkling clean; the machine cleaning composition was highly effective and the scale was efficiently removed.

### EXAMPLE 2

### MGDA Tab

A machine cleaning composition was prepared containing the following components:

| | |
|---|---|
| Methyl-glycine-diacetic acid (MGDA) - | 10.5 g |
| Non-ionic surfactant (PLURAFAC LF 400) - | 1.5 g |
| Polymer (ACUSOL 445 - acrylic homopolymer: | 0.5 g |
| dispersant/scale preventative/soil anti- | |
| deposition agent) | |

The powder was encased in a PVOH water soluble skin, to make a tablet.

The method used was as follows

### Substrate Preparation:

Small marble stone cubes of approximately the same size (approximately 2 cm×2 cm×1.8 cm) and weight (20.5-21.5 g) were submerged in demineralised water for at least one hour as a pre-treatment. Afterwards, they were dried thoroughly and weighed.

Marble stone cubes were used as an objective, reliable way of assessing performance against scale.

### Test Procedure:

A dried marbled cube of known weight was placed directly in the main body of a Miele G 676 SC dishwasher using a sieve. A FINISH POWERBALL (Registered Trade Mark) tablet was placed in the compartment and the “Universal 65°” cycle was started. At the end of the cycle the marble cube was submerged in demineralised water to remove any cleaner residues and dried.

The loss in weight was measured and expressed as a percentage of the initial weight. Comparison was made with the tablet of Example 1, and with 15 g of citric acid and 20 g of MGDA, both “neat”, the results being as follows:

Miele G 676 SC, 65° C. Universal program

| dosage in prewash | dosage in main | |
|---|---|---|
| (bottom | wash | |
| compartment) | (main chamber) | weight loss [%] |
| Nothing | Nothing | 0.003 |
| Nothing | Finish Powerball | 0.054 |
| | tab | |
| 15 g citric acid | Finish Powerball | 0.331 |
| | tab | |
| Example 1 tab | Finish Powerball | 0.392 |
| | tab | |
| 20 g MGDA | Finish Powerball | 0.248 |
| | tab | |
| Example 2 tab | Finish Powerball | 0.122 |
| | tab | |

Although the MGDA tablet is not optimised it is clear that MGDA provides a scale preventive and/or removal action.

1. A process for cleaning an automatic dishwashing machine during a working cycle thereof, the machine being loaded with kitchenware articles to be cleaned, the process comprising delivery into the machine of a machine cleaning composition, followed by delivery into the machine of a dishwashing composition.

2. A process according to claim 1 carried out in a machine having a main washing chamber and a compartment for the dishwashing composition, the process comprising the steps of:
adding a machine cleaning composition directly to the main washing chamber of the machine;
charging the delivery compartment with the dishwashing composition; and
running a working cycle of the machine with the kitchenware articles in it;
wherein said working cycle selected includes a pre-wash stage;
wherein the machine cleaning composition is active in the pre-wash stage and the dishwashing composition is released from the delivery compartment only in the main wash stage.

3. A process according to claim 1 wherein the machine cleaning composition comprises an acid.

4. A process according to claim 3 wherein the machine cleaning composition comprises an organic acid and an inorganic acid.

5. A process according to claim 1 wherein the machine cleaning composition comprises a builder.

6. A process according to claim 1 wherein the machine cleaning composition includes a turbidity agent.

7. A process according to claim 1 wherein the machine cleaning composition is provided in the form of a tablet.

8. A method for cleaning of an automatic dishwashing machine during a pre-wash stage of a working cycle of the machine the method comprising the step of providing an acid containing machine cleaning composition which is present in the automatic dishwashing machine during a pre-wash stage of a working cycle of the machine.

9. A method to effect cleaning of an automatic dishwashing machine during a working cycle of the machine, the method comprising providing a builder to the automatic dishwashing machine during a working cycle of the machine.

10. A method for combating scale in an automatic dishwashing machine, the method comprising the step of providing MGDA to the automatic dishwashing machine.

11. A machine cleaning composition comprising a compound which counteracts calcium or magnesium ions, and/or scale or scum formed thereby, further comprising a turbidity agent.

12. A process according to claim 4 wherein the machine cleaning composition comprises an organic acid selected from one or more of citric acid and malic acid.

13. A process according to claim 4 wherein the machine cleaning composition comprises as an inorganic acid, sulfamic acid.

14. A process according to claim 5 wherein the machine cleaning composition comprises as builder, MGDA.
